(19) United States
(12) Patent Application Publication
(10) Pub. No.: US 2004/0203536 A1
(43) Pub. Date: Oct. 14, 2004

(54) Portable electronic device

(76) Inventors: Wang Tien Chao, Tu-chen (TW); Chun Jen Lin, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/822,895

(22) Filed: Apr. 12, 2004

(30) Foreign Application Priority Data
Apr. 11, 2003 (TW) 92205665

(51) Int. Cl. H04Q 7/20

(52) U.S. Cl. 455/90.3

(57) ABSTRACT

A portable electronic device (1) of the present invention includes an antenna duplexer (10), an antenna (20), a cover (40), and a button (42). The antenna duplexer (10) performs a switching between transmit and receive signals. A switch (30) is electrically connected between the antenna duplexer (10) and the antenna (20). The button controls the opening and closing of the switch. By pushing the button between two positions, a user connects or disconnects the switch, thereby confining entering calls for the electronic device mobile phone function. Other functions of the mobile phone thus will operate without interruptions when the switch (30) is opened.

### BACKGROUND OF THE INVENTION

1. Field of the Invention

The present invention generally relates to portable electronic devices, and more particularly to a portable electronic device, which provides a user with a call confining function.

2. Prior Art

Currently, portable electronic devices, such as mobile phones, provide users with not only the basic voice communications function, but also with many additional functions, such as camera, MP3-player and personal assistant functions. So users can now regard their portable electronic devices as a portable camera or a portable MP3-player, besides being a mobile phone. For example, one mobile phone, the Nokia 7650, now has not only the main function of voice communications, but also has game-player and camera functions. Oftentimes, users use it as a game box or a portable camera. Likewise users of Siemens 6688 often use it as an MP3-player.

However, the main telephony function module and the additional function modules of these existing portable electronic devices are usually controlled by a same switch, for example, a power key. When the power is on, all the modules are activated and are in a standby mode, waiting for a suitable command. When the power is off, all the functions are disabled. When these existing portable electronic devices are in the power on mode, especially during a period of taking pictures or listening to music, lower priority functions, such as the camera or music player, can be interrupted by conventional calls or short messages, unless the device has been previously customized.

The Siemens 6688 mobile phone is susceptible to such interruptions. When the power is on, if the MP3-player is playing, an entering call will disable the operation of the MP3-player circuitry. This may be annoying to the user.

Therefore, a portable electronic device providing a call confining function is desired.

### SUMMARY OF THE INVENTION

Accordingly, an object of the present invention is to provide a portable electronic device, which provides users with a call confining function.

To achieve the above-mentioned object, a portable electronic device of the present invention includes an antenna duplexer, an antenna, and a switch. The antenna duplexer performs switching between transmitting and receiving signals. The switch is electrically connected with either the antenna duplexer or the antenna. When the switch is turned off, the antenna and the antenna duplexer are disconnected. Thus, the antenna duplexer will not accept the signals, and incoming calls cannot interrupt other functions.

### BRIEF DESCRIPTION OF THE DRAWINGS

FIG. 1 is a perspective view of a mobile phone in accordance with a preferred embodiment of the present invention; and

FIG. 2 is a simplified electronic schematic diagram of an antenna duplexer circuit.

### DETAILED DESCRIPTION OF THE INVENTION

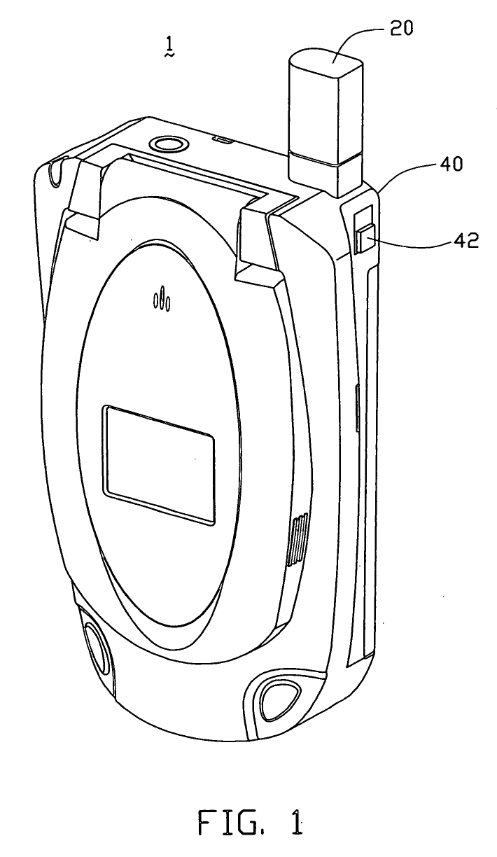

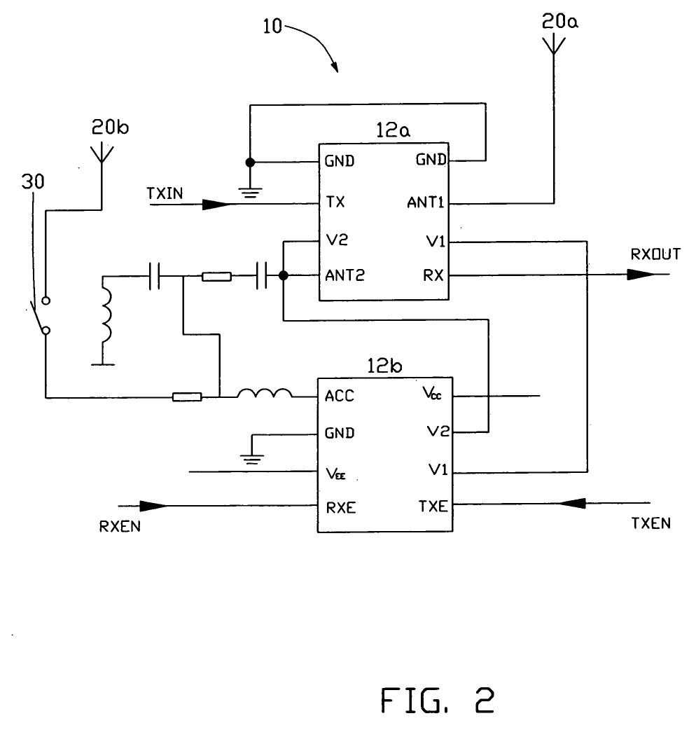

Referring to FIGS. 1 and 2, a mobile phone 1 is used as an example of a portable electronic device according to a preferred embodiment of the present invention. The mobile phone 1 comprises a cover 40, an antenna 20 extending out of the cover 40, and a button 42 mounting on a sidewall of the cover 40. Within the cover 40, the mobile phone 1 further includes an antenna duplexer 10 and a switch 30 which is operated by the button 42. The antenna 20 comprises a receiving antenna 20b. The switch 30 controls the operation of the receiving antenna 20b.

Schematically, the antenna 20 is represented by a transmitting antenna 20a, which is used to send signals, and a receiving antenna 20b, which is used to receive signals. In the actual system, because the frequency band used for transmitting signals is different from the frequency band used for receiving signals, the transmitting antenna 20a and the receiving antenna 20b are one unitary antenna 20.

The antenna duplexer 10 comprises a first IC (integrated circuit) 12a, a second IC 12b, and some assisting discrete component (not labeled). The first IC 12a is positioned between the transmitting antenna 20a and the receiving antenna 20b, and determines which one of the two antennas should operate. The pin ANT1 is connected to the transmitting antenna 20a, and the pin ANT2 is connected to the receiving antenna 20b. The pin TX is connected with a power amplifier (not shown) and receives output signals TXIN from the power amplifier. The pin RX sends output RF (Radio Frequency) signals RXOUT received from the antenna 20 to a filter (not shown). The pins V1 and V2 transmit and receive control signals between the first IC 12a and the second IC 12b with the switch commands.

The two pins TXE and RXE of the IC 12b are connected to a Microprogrammed Control Unit (MCU) (not shown) and receive the transmitting and receiving control signals TXEN or RXEN from the MCU, respectively. The switch 30 enables or interrupts normal operation of the internal circuitry by connecting or disconnecting the receiving antenna 20b. Providing the switch 30 is closed, when the pin TXE receives signals from the MCU, the IC 12a enables the transmitting antenna 20a; when the pin RXE receives signals from the MCU, the IC 12a enables the receiving antenna 20b. The pin ACC receives the detecting signals from the antenna 20. If the antenna 20b is operating, the IC 12b will control the IC 12a via the two pins, V1 and V2 to disconnect the transmitting antenna 20a, and vice versa.

The antenna duplexer 10 can switch operation of the antenna 20 between transmitting and receiving, as needed. When the transmitting antenna 20a and the receiving antenna 20b work at the same time, the receiving antenna 20b will have priority of connection. The antenna duplexer 10, the switch 30, and the receiving antenna 20b are connected in series with the switch 30 establishing or breaking a connection therebetween.

The button 42 mechanically opens or closes the switch 30, thereby activating the switch 30, and is mounted on a sidewall of the mobile phone 1.

Users can open or close the switch 30, thereby disconnecting or connecting the antenna 20b with the IC 12b, by sliding the button 42 up or down. When the switch 30 closed, the antenna duplexer 10 electrically connects with the receiving antenna 20b, thus the mobile phone 1 can work as an ordinary phone. That is to say, when an incoming call arrives, the secondary functions, such as the camera or music player, will be interrupted, so that the call can be picked up. When users don't want to be interrupted by unexpected calls, they can open the switch 30, thus disconnecting the antenna duplexer 10 from the receiving antenna 20b. In this case, the IC 12b will not be able to detect the receiving antenna 20b, so the entering call is blocked.

For the above description, it is clear that the mobile phone 1 of the present invention can confine entering calls according to a user's needs, and at the same time, other secondary functions of the mobile phone can be used without interruptions.

It is believed that the present invention and its advantages will be understood from the foregoing description and it will be apparent that various changes may be made thereto without departing from the spirit and scope of the invention or sacrificing all of its material advantages, the examples hereinbefore described merely being preferred or exemplary embodiments of the invention.

We claim:

1. A portable electronic device, comprising:
an antenna duplexer;
an antenna used for transmitting or receiving the signals; and
a switch positioned between the antenna duplexer with the antenna, wherein, when the switch is closed, the antenna duplexer, the switch and the antenna will be electrically connected, and when the switch is open, the antenna duplexer and antenna will be disconnected.

2. The portable electronic device as claimed in claim 1, further comprising a cover.

3. The portable electronic device as claimed in claim 2, wherein the switch is mechanically connected to a button on the cover, such that when the button slides to one side, it closes the switch, and when the button slides to an opposite side, it opens the switch.

4. A portable electronic device having a control apparatus and an antenna used for transmitting or receiving signals, comprising:
an entering calls confining apparatus, which can make an electronic connection between the control apparatus and the antenna, so that entering calls are accepted, and can disconnect the control apparatus from the antenna so that entering calls are blocked.

5. The portable electronic device as claimed in claim 4, wherein said control apparatus is an antenna duplexer.

6. The portable electronic device as claimed in claim 4, wherein said entering call confining apparatus is a switch.

7. The portable electronic device as claimed in claim 6, further comprising a cover, including the control apparatus and the entering call confining apparatus therein.

8. The portable electronic device as claimed in claim 7, wherein a button controlling said switch is positioned on the cover.

9. A method of using a multi-functional cellular phone comprising steps of:
providing an antenna;
providing electrical circuits operating and operated by said antenna; and
providing a switch accessible from an exterior; wherein
when said cellular phone is performed for non-communication usages including picture taking or music playing, the antenna does not function under a condition of the switch being activated for such disconnection.
